(19) United States
(12) Patent Application Publication
(10) Pub. No.: US 2017/0061747 A1
(43) Pub. Date: Mar. 2, 2017

(54) Doorbell Transmitter

(71) Applicant: Cinch Systems, Inc., St. Michael, MN (US)

(72) Inventors: Joel Curtis Christianson, Corcoran, MN (US); William Williamson, III, Rochester, MN (US); Michael E. Loukusa, Buffalo, MN (US)

(21) Appl. No.: 14/836,482

(22) Filed: Aug. 26, 2015

(51) Int. Cl. G08B 3/10

(52) U.S. Cl. CPC G08B 3/1016

(57) ABSTRACT

A device includes a controller. An input is coupled to the controller, the input having a set of wires to couple to a doorbell to receive an AC signal when the doorbell is actuated. An analog to digital converter is coupled to the input to convert the received AC signal to a digital signal and coupled to the controller to provide the digital signal to the controller. A transmitter is coupled to the controller to wirelessly transmit signals from the controller representative to actuation of the doorbell. An enclosure contains the controller, input, analog to digital converter and transmitter and has an opening to provide a passage outside the enclosure for the set of wires. The controller may be programmable via an optical signal and may provide alerts responsive to a temperature sensor.

### BACKGROUND

Security systems sense many different home and building intrusion attempts. Sensors are coupled to doors and windows and transmit signals to a controller when the doors and windows are opened. Glass break and motion detectors may also be used to detect intrusion attempts. Still further fire and smoke alarms, temperature sensors and other sensors may be used in security systems.

### SUMMARY

A device includes a controller. An input is coupled to the controller, the input having a set of wires to couple to a doorbell to receive an AC signal when the doorbell is actuated. An analog to digital converter is coupled to the input to convert the received AC signal to a digital signal and coupled to the controller to provide the digital signal to the controller. A transmitter is coupled to the controller to wirelessly transmit signals from the controller representative to actuation of the doorbell.

In some embodiments, an enclosure contains the controller, input, analog to digital converter and transmitter and has an opening to provide a passage outside the enclosure for the set of wires. The controller may be programmable via an optical signal and may provide alerts responsive to a temperature sensor.

### BRIEF DESCRIPTION OF THE DRAWINGS

FIG. 1 is a block diagram illustrating a security system transmitter according to an example embodiment.

FIG. 2 is a circuit diagram illustrating further details of the transmitter of FIG. 1.

FIG. 3 is a flowchart illustrating a method of detecting a doorbell actuation according to an example embodiment.

FIG. 4 is a flowchart illustrating a method of sensing temperature and providing an alert according to an example embodiment.

FIG. 5 is a flowchart illustrating method of programming a controller of a transmitter according to an example embodiment.

FIG. 6 is a perspective view of a security system transmitter according to an example embodiment.

FIG. 7 is a block diagram illustrating an architecture for a controller of a transmitter according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

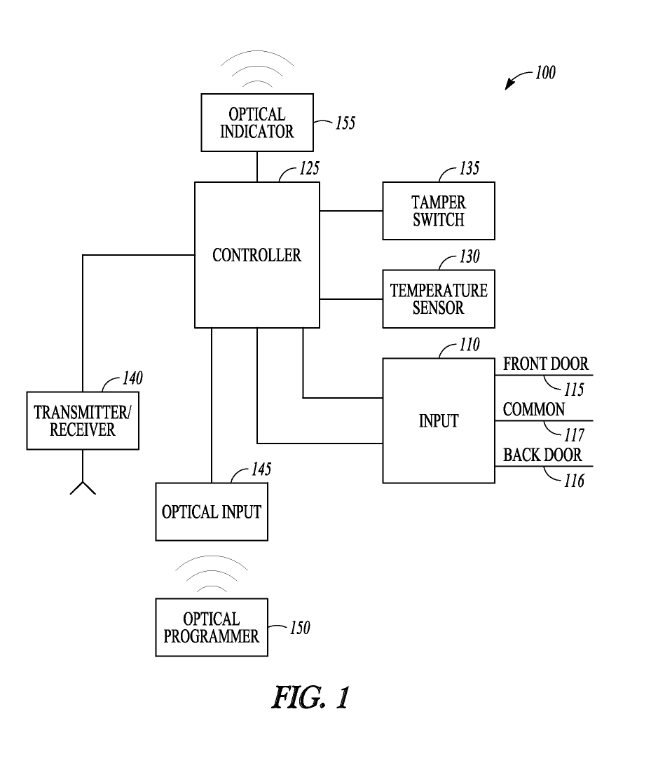

FIG. 1 is a block diagram illustrating a security system transmitter 100 according to an example embodiment. An input circuit 110 is supported by a circuit board and includes a set of wires 115, 116, and 117 in one embodiment. Wire 115 is coupled to the input circuit such as by solder, and is for connection to a doorbell such as a front door doorbell. Wire 116 is similarly coupled to the input circuit and is for connection to a second doorbell, such as a back door doorbell. Wire 117 is a common wire. The input 110 converts signals from the doorbells to digital signal levels and provides separate signals to a controller 125 such as a microcontroller indicative of actuation of the doorbells. While two doorbell wires are shown, only one may be used in some embodiments, and further wires for additional doorbells may be provided in still further embodiments.

Controller 125 may also be coupled to a temperature sensor 130, such as a thermistor that provides signals representative of sensed temperature to controller 125. A tamper switch 135 may also be coupled to the controller 125 to provide signals representative of tampering. For instance, the tamper switch may contain a physical switch which engages a protrusion of a cover of an enclosure that encloses the controller and other circuitry, all of which may be supported by a circuit board. Removal of the cover releases the switch, generating a tamper signal.

Controller 125 may generate one or more alerts based on signals received from the input 110, temperature sensor 130, and tamper switch 135. A transceiver 140, which may operate only in a transmission mode in one embodiment, is coupled to the controller and is used by the controller to wirelessly transmit signals representative of the alerts via an antenna. In further embodiments, the status of an alarm condition may be provided periodically after a first report of the alarm condition. For example, if a freeze alarm has a trip point of 42° F., the temperature may be re-checked after N minute intervals. In some embodiments, the actual temperature may be transmitted. While the input 110 in one embodiment is shown as a doorbell sensor, the input 110 may alternatively be a contact type sensor for indicating opening of a window or door, a glass break sensor, a motion sensor, or any other type of sensor commonly used in security systems.

In one embodiment, transmitter 100 may include an optical input 145 that is coupled to the controller 125. The optical input 145 may be a photodetector that receives optical pulses from an optical programmer 150. The optical pulses in one embodiment comprises a series of four optical pulses of varying length corresponding to a four bit digital code. The lengths in one embodiment comprises short and long pulses, corresponding to “0” and “1” values for the four bits. The optical input 145 provides signals representative of the four bit digital code to the controller 125, which decodes the signals into the four bits and uses the four bits to lookup a program to execute on the controller. The bits may simply provide an offset into memory, or may be contained in a table with an associated offset. The controller will then be reprogrammed from factory settings to perform the program identified by the optical pulses.

In one embodiment, an optical indicator 155 is coupled to the controller and is driven to display optical pulses corresponding to the four bit digital code, which match the pulses provided by the optical programmer 150. The controller 125 in one embodiment causes repeating of the display of optical pulses for a set period of time after receiving the optical pulses from the optical input 145. In further embodiments, a user may physically actuate the tamper switch 135 or another switch to cause display of the currently selected program for execution on the controller 125. Replacing the cover also actuates the tamper switch 135, holding it in a depressed condition, resulting in shutting down the optical indicator 155, which may comprise light emitting diodes.

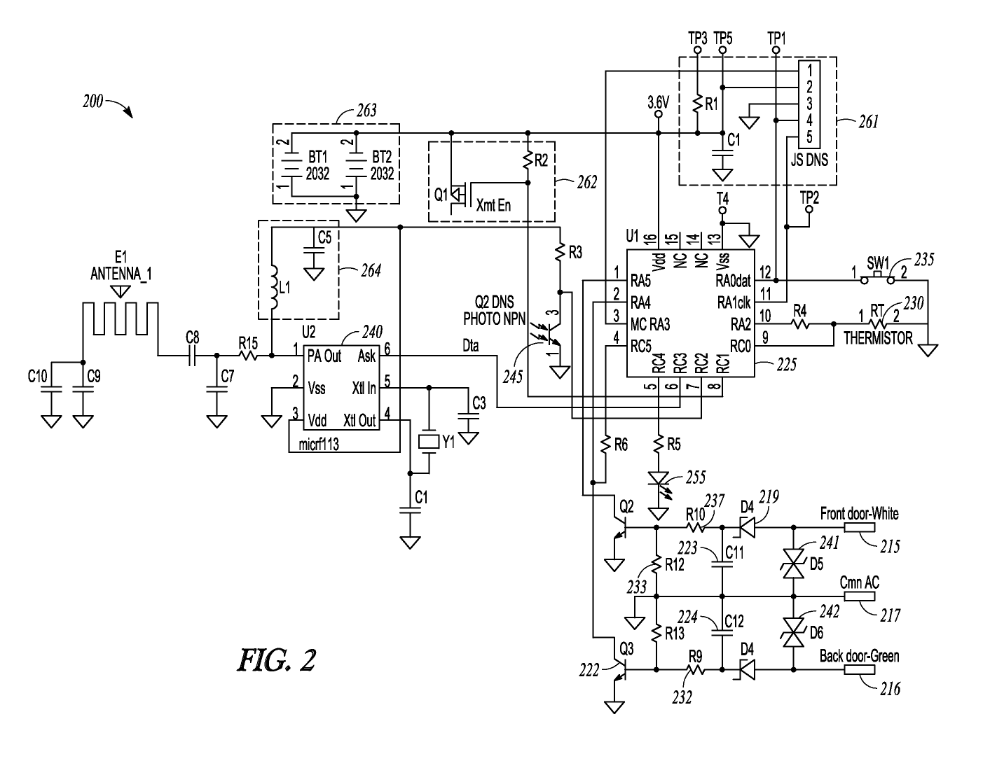

FIG. 2 is a circuit diagram illustrating further details of the transmitter of FIG. 1 at 200. Reference numbers in FIG. 2 are similar to those of FIG. 1 for like parts, but begin with a “2” instead of a “1”. Front and back door schematic inputs are shown at 215, 216, and 217, and may be connected in parallel with front and back door connections on a doorbell. The circuit common input 217 may also be connected to a common input on the doorbell.

When a doorbell pushbutton is pressed a 60 hertz 16 VAC appears across that doorbell input and common. The AC voltage is rectified via a half wave pass diode 219 (for the front door) and 220 (for the back door) and the positive portion of the AC is sent to a respective transistor base, either Q2 at 221 or Q3 at 222 respectively. A capacitor C11 at 223 or C12 at 224 filter the respective half waves to provide a DC current to Q11 or Q12 base through R10 at 231 and R9 at 232. R12 at 233 and R13 at 234 provide a path to dissipate the DC voltage. The collectors of Q2 and Q3 are separately connected to microcontroller 225 inputs. A low signal to either input will activate the microcontroller to output an RF packet to the RF transceiver integrated circuit 140. The packet contains information that identifies the reporting location and which premise doorbell was pressed.

In some embodiments, transient suppressing diodes 241 and 242 may coupled between the respective input connectors 215 and 216 to common 217. The diodes 241 and 242 may suppress currents resulting from lightning strikes, and transients resulting from the AC signal initially being applied when a doorbell is actuated.

In one embodiment, the transmitter 200 may have a circuit board supporting the components and may be enclosed within an enclosure with an opening for the set of wires. The transmitter enclosure may be mounted in very close proximity to the premise doorbell enunciator. The transmitter may be wired in parallel with the doorbell front and back door (if separate) AC inputs to a doorbell enunciator. When the appropriate bell pushbutton is pressed an AC voltage appears across either the front door (F to Cmn) or back door (B to Cmn) inputs to the transmitter. A few 60 Hz AC Half wave signals over a half second duration are voltage accumulated and will be detected by Q2 at 221 or Q3 at 222 and their output low signal is sent to processor 225. The processor 225 then sends an appropriate report signal to a system alarm panel such as via transceiver 240, which may be a integrated circuit (IC) transmitter only in some embodiments and need not have transmit capabilities. The panel may then relay the signal to an appropriate off-premise individual or location. This procedure is typically done when the house is unoccupied and the security system is armed.

Door Bell enunciators may be provided AC power from 16 VAC Class II transformers. The transformers Class II transformers voltage output is nominal 16 or 24 VAC at the rated power load specified by the transformer.

In further embodiments, different method of detecting activation or actuation of a doorbell may be utilized, such as a current sense method. Optical isolators may be used in such a method to sense current resulting from a doorbell being pressed or otherwise actuated.

In addition to reporting DB activation, the transmitter 200 may also monitor premise temperature. The transmitter 200 has a factory programmed detector that will report a low temperature condition when a nominal 42 F trip point, also referred to as a threshold, is detected. A method for changing this report trip point to a different low temperature trip point—or reverse the trip point to report on a selected high temp trip point—or report if either (out of normal) condition is detected may also be provided. Still further, a range of normal temperatures may be indicated by two trip points, and either exceeding or falling below the respective high and low trip points may trigger a report.

The alternate temperature report trip points can be installer selected from a temperature report menu that includes up to 15 variations of report conditions. These modified temperature conditions may be pre-programmed in controller 225. Selection of a program variation may be made by a Sniffer/Programmer module as indicated at 150 in FIG. 1.

The sniffer module 150 may provide an input mechanism for selecting a four bit digital code in one embodiment, each variation of the code corresponding to a program variation which may be identified via a manual or descriptive information on the sniffer module 150 depending on processing and user interface capabilities of the sniffer module 150. Note that in further embodiments, other types of transmitters may have similar variations selected for execution by a controller via the sniffer module 150.

In one embodiment, the sniffer module 150 has four dip switches on it which allow selection of up to 15 different preset conditions and a 16th (all switches off) selection to return the transmitter to factory its factory default condition. The optional selections may be accomplished by using an IR optical transistor 245 for receiving the desired option selection via a serial IR transmission from the sniffer module 150, and a visual LED 255 coupled to the controller and located on the circuit board to visibly “pulse blink” the selection if an option is programmed. When the cover is removed from the DB transmitter visual LED 255 becomes visible to a user.

Additional details of circuitry in transmitter 200 is shown by multiple broken lines. Broken line 261 includes circuitry that provides a programming input for the controller 225, and may be used to provide factory settings and the optional programming described herein. Broken line 262 includes circuitry to provide a power output for the transceiver 240. Broken line 263 identifies batteries for providing power to the transmitter 200. Broken line 264 includes a power inductor for an RF output stage of the transceiver 240.

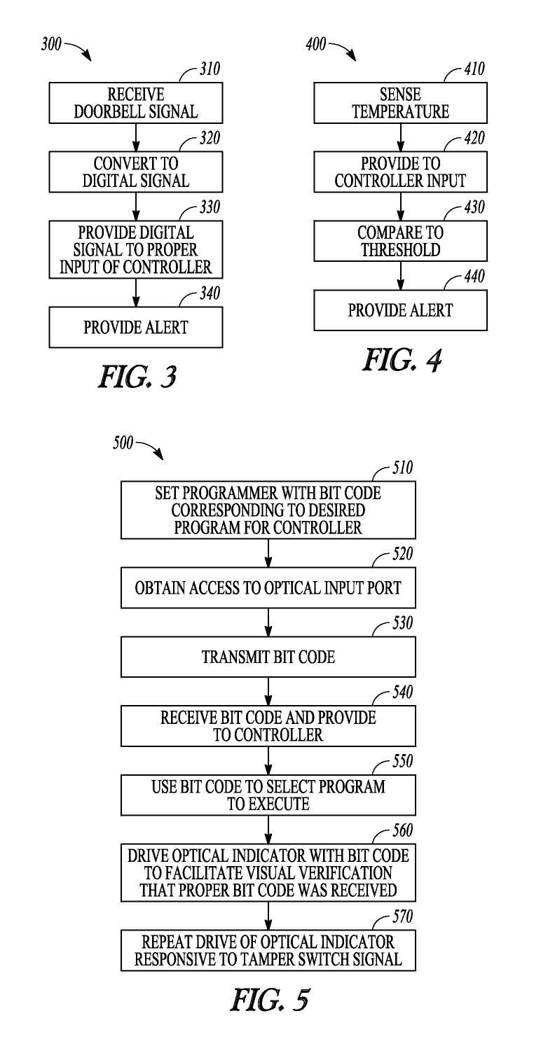

FIG. 3 is a flowchart illustrating a method 300 of detecting a doorbell actuation according to an example embodiment. At 310, a doorbell signal is received. The doorbell signal is converted to a digital signal at 320 and the digital signal is provide to a proper input of the controller at 330. The controller prepares an alert at 340 and may send the alert to the transceiver for transmission to a control panel and optional further transmission to a monitoring service should be control panel be in a secure mode, such as an away mode.

FIG. 4 is a flowchart illustrating a method 400 of sensing temperature and providing an alert according to an example embodiment. At 410, the temperature is sensed periodically. A signal representative of the sensed temperature is provided to the controller input at 420. The controller compares the signal to a trip point, also referred to as a threshold, at 430. The comparison may meet or exceed the trip point, or may meet or fall below the trip point in different embodiments, resulting in an alert being generated.

FIG. 5 is a flowchart illustrating method 500 of programming a controller of a transmitter according to an example embodiment. An optical programmer, also referred to as a sniffer module, is set with a bit code corresponding to a desired program for the controller at 510. The bit code may be set via physical or virtual jumper switches, or via a graphical user interface in various embodiments to correspond to a desired program variation. As previously indicated, some variations include variations in trip point temperatures, temperature ranges, and whether the trip point is exceeded or fallen below. These variations can be helpful where transmitters are installed in different areas of a structure being monitored. For example only, if a transmitter is located near an outer wall of the structure, a lower trip point may be desired as opposed to the transmitter being located in a naturally warmer part of the structure.

At 520, access to an optical input port is obtained. This may be done by removing an enclosure cover, and may also be facilitated by a tamper switch indicating the cover has been removed. Once access is obtained, the sniffer module is activated to transmit the bit code at 530. The transmission may be made via a light emitting diode that transmits light pulses of different duration serially. The durations may be a few milliseconds for a pulse corresponding to a logical “0” and several milliseconds for a pulse corresponding to a logical “1”, with a selected number of milliseconds between pulses and a longer delay between a repetition of the code. The code may be sent once, or multiple times.

At 540, the light pulses are received and provided to the controller. The controller converts the light pulses to the bit code and uses the bit code to select the program variation to execute at 550. At 560, the controller may drive an optical indicator with pulses corresponding to the bit code to facilitate visual verification that the proper bit code was received. The transmission may continue for a set time, such as one minute, with delays between each transmission of the bit code. The timing between and length of the pulses may be the same as or different than the pulses transmitted by the sniffer module. At 570, the transmission may be driven by the controller responsive to actuation of the tamper switch, which may be done by a user/installer pressing a physical tamper switch.

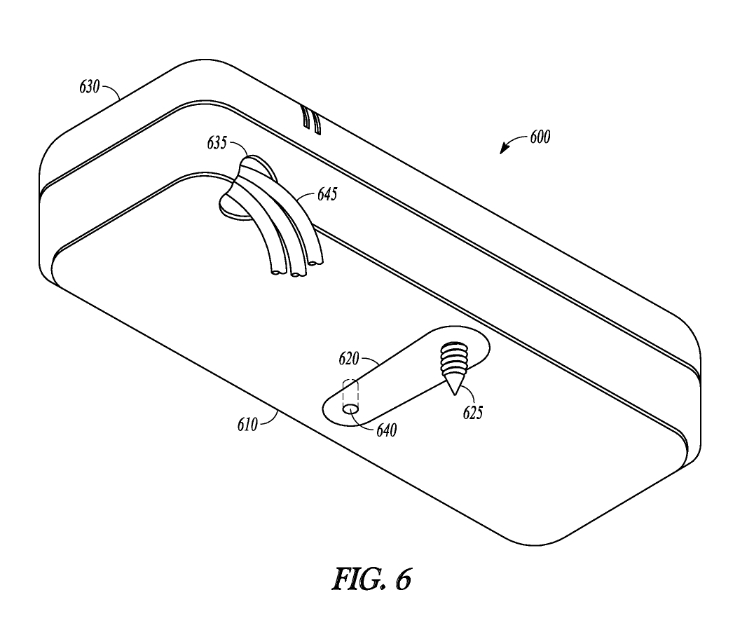

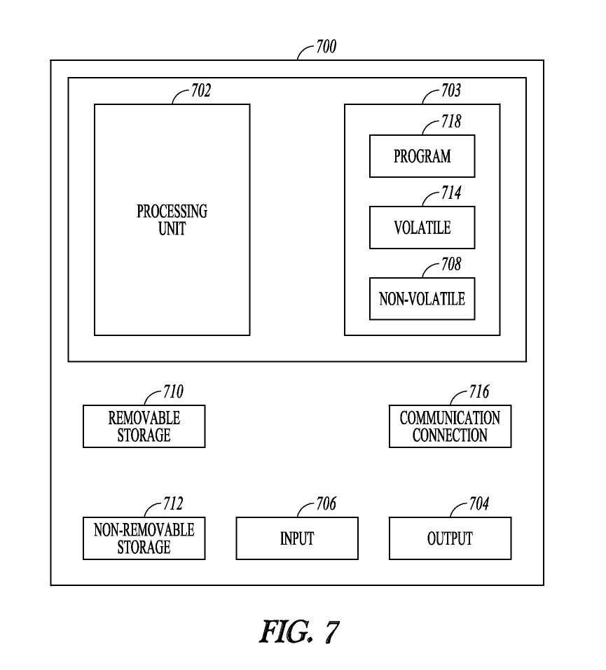

FIG. 6 is a perspective view of a security system transmitter 600 according to an example embodiment. Transmitter 600 in one embodiment includes an enclosure that has a base 610 for coupling to a wall or other structure via a tamper panel 615 that is coupled to the base via one or more tabs 620 that operate to break away from the enclosure and trigger a tamper alarm. The tamper panel 615 may be secured to a structure via a screw 625. A releasable cover 630 is coupled to the base 610 via one or more releasable mating protrusions. The cover 630 in one embodiment holds the circuit board in place, and when removed, a protrusion 635 extending from the tamper panel inside the enclosure to the tamper switch on the circuit board releases the switch, triggering a tamper alert.

In one embodiment, the base 610 comprises an opening 640. The opening may be punch out in one embodiment, and is used to facilitate exit of the set of wires indicated at 645 from the enclosure base 610 such that the set of wires may be coupled to a doorbell.

FIG. 7 is a block diagram illustrating an architecture for a controller of a transmitter according to an example embodiment. A computer system 700 may be used to implement methods according to example embodiments. All components need not be used in various embodiments. One example computing device in the form of a computer 700, may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, or other computing device including the same or similar elements as illustrated and described with regard to FIG. 7. Devices such as smartphones, tablets, and smartwatches are generally collectively referred to as mobile devices. Further, although the various data storage elements are illustrated as part of the computer 700, the storage may also or alternatively include cloud-based storage accessible via a network, such as the Internet.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input 706, output 704, and a communication connection 716. Output 704 may include a display device, such as a touchscreen, that also may serve as an input device. The input 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 702 of the computer 700. A hard drive, CD-ROM, and RAM are some examples of articles including a non-transitory computer-readable medium such as a storage device. The terms computer-readable medium and storage device do not include carrier waves. For example, a computer program 718 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 700 to provide generic access controls in a COM based computer network system having multiple users and servers.

### Examples

1. A device comprising:

a controller;

an input coupled to the controller, the input having a set of wires to couple to a doorbell to receive an ac signal when the doorbell is actuated;

an analog to digital converter coupled to the input to convert the received AC signal to a digital signal and coupled to the controller to provide the digital signal to the controller;

a transmitter coupled to the controller to wirelessly transmit signals from the controller representative to actuation of the doorbell; and

an enclosure containing the controller, input, analog to digital converter and transmitter and having an opening to provide a passage outside the enclosure for the set of wires.

2. The device of example 1 and further comprising a circuit board disposed within the enclosure and supporting each of the controller, input, analog to digital converter, and transmitter.

3. The device of example 2 wherein the set of wires are soldered to the circuit board.

4. The device of any of examples 1-3 wherein the analog to digital converter comprises:

a rectifier;

a resistor and capacitor coupled to the rectifier; and

a switch coupled to the capacitor to turn on responsive to the received ac signal being rectified by the rectifier and integrated by the resistor and capacitor.

5. The device of any of examples 1-4 wherein the set of wires comprises:

a first wire to couple to a first doorbell;

a second wired to couple to a second doorbell; and

a common wire.

6. The device of example 5 wherein the analog to digital converter comprises a pair of analog to digital converters, each coupled to a respective one of the first and second wires, and wherein the pair of analog to digital converter are coupled separately to the controller.

7. The device of any of examples 1-6 and further comprising a temperature sensor coupled to the controller.

8. The device of example 7 wherein the temperature sensor comprises a thermistor.

9. The device of any of examples 1-8 and further comprising a tamper sensor coupled to the controller.

10. A method comprising:

receiving an AC signal from a doorbell via a set of wires upon actuation of the doorbell;

converting the received AC signal to a digital signal;

providing the digital signal to a controller to generate an alert responsive to the digital signal indicating actuation of the doorbell; and

transmitting the alert via a wireless transmitter coupled to the controller.

11. The method of example 10 wherein the method is performed by components supported by a circuit board disposed within an enclosure and wherein the set of wires extend from the circuit board outside the enclosure via an opening in the enclosure.

12. The method of example 11 wherein converting the received ac signal to a digital signal comprises:

rectifying the received ac signal;

integrating the received rectified ac signal; and

turning on a switch responsive to the integrated received rectified ac signal.

13. The method of any of examples 10-12 wherein the set of wires are coupled to two doorbells and converting the received ac signal to a digital signal comprises separately converting the ac signals from the two doorbells and separately providing the converted signals to the controller.

14. The method of any of examples 10-13 and further comprising providing a temperature signal to the controller responsive to sensed temperature.

15. The method of any of examples 10-13 and further comprising providing a tamper signal to the controller responsive to a tamper switch.

16. A machine readable storage device having instructions for execution by a circuitry to perform a method comprising:

receiving an AC signal from a doorbell via a set of wires upon actuation of the doorbell;

converting the received AC signal to a digital signal;

providing the digital signal to a controller to generate an alert responsive to the digital signal indicating actuation of the doorbell; and

transmitting the alert via a wireless transmitter coupled to the controller.

17. The machine readable storage device of example 16 wherein the circuitry is supported by a circuit board disposed within an enclosure and wherein the set of wires extend from the circuit board outside the enclosure via an opening in the enclosure.

18. The machine readable storage device of any of examples 16-17 wherein converting the received AC signal to a digital signal comprises:

rectifying the received AC signal;

integrating the received rectified AC signal; and

turning on a switch responsive to the integrated received rectified ac signal.

19. The machine readable storage device of any of examples 16-18 wherein the set of wires are coupled to two doorbells and converting the received AC signal to a digital signal comprises separately converting the ac signals from the two doorbells and separately providing the converted signals to the controller.

20. The machine readable storage device of any of examples 16-19 wherein the method further comprising:

providing a temperature signal to the controller responsive to sensed temperature; and.

providing a tamper signal to the controller responsive to a tamper switch.

21. A device comprising:

a controller;

an input coupled to the controller to sense a security parameter and to provide a digital signal to the controller responsive to the sensed security parameter;

a transmitter coupled to the controller to wirelessly transmit signals from the controller responsive to the digital signal; and

an optical input device coupled to the controller to receive optical pulses and provide a program selection signal to the controller responsive to the received optical pulses.

22. The device of any of examples 1-9 and 21 wherein the controller comprises:

a storage device having multiple stored programs; and

circuitry for selecting one of the multiple stored programs for execution responsive to the received optical pulses.

23. The device of example 22 wherein the input comprises a temperature sensor.

24. The device of example 23 wherein the temperature sensor comprises a thermistor.

25. The device of example 22 wherein the multiple stored programs comprise:

a first program responsive to sensed temperature exceeding a high threshold; and

a second program responsive to sensed temperature falling below low threshold.

26. The device of example 22 wherein the multiple stored programs comprise a third program responsive to sensed temperature moving out of a selected range of temperatures.

27. The device of any of examples 21-26 and further comprising an optical indicator coupled to the controller.

28. The device of example 27 wherein the controller is operable to drive the optical indictor to display the received optical pulses responsive to receipt of the digital pulses.

29. The device of any of examples 21-28 wherein the optical pulses comprises long and short pulses, each corresponding to the value of a bit.

30. The device of example 29 wherein the optical pulses comprise four optical pulses in sequence corresponding to a four bit code.

31. The device of any of examples 27-30 and further comprising a user actuatable switch coupled to the controller, the controller responsive to actuation of the switch to drive the optical indicator to display optical pulses corresponding to a currently selected program.

32. The device of example 31 wherein the switch comprises a tamper switch.

33. A method comprising:

receiving optical pulses and providing signals representative of the optical pulses to a controller;

interpreting the signals provided to the controller as a program selection signal;

selecting one of multiple programs stored on the controller for execution by the controller responsive to the program selection signal.

34. The method of example 33 wherein the multiple stored programs comprise:

a first program responsive to a sensed parameter exceeding a high threshold; and

a second program responsive to the sensed parameter falling below a low threshold.

35. The method of example 34 wherein the sensed parameter is temperature.

36. The method of any of examples 33-35 wherein the controller is operable to drive an optical indictor to display the program selection signal as optical pulses responsive to receipt of the signals provided to the controller.

37. The method of any of examples 33-36 wherein the optical pulses comprises long and short pulses, each corresponding to the value of a bit.

38. The method of any of examples 33-37 and further comprising displaying optical pulses corresponding to a currently selected program responsive to receipt of the signals representative of the optical pulses

39. The method of any of examples 33-38 and further comprising displaying optical pulses corresponding to a currently selected program responsive to actuation of a physical switch.

40. A machine readable storage device having instructions for execution by a circuitry to perform a method comprising: receiving optical pulses and providing signals representative of the optical pulses to a controller;

interpreting the signals provided to the controller as a program selection signal;

selecting one of multiple programs stored on the controller for execution by the controller responsive to the program selection signal.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device comprising:
a security system controller;
an input coupled to the security system controller, the input having a set of wires to couple to a doorbell to receive an ac signal when the doorbell is actuated;
an analog to digital converter coupled to the input to convert the received AC signal to a digital signal and coupled to the security system controller to provide the digital signal to the controller;
a transmitter coupled to the controller to wirelessly transmit signals from the security system controller representative to actuation of the doorbell via an antenna; and
an enclosure containing the security system controller, input, analog to digital converter and transmitter and having an opening to provide a passage outside the enclosure for the set of wires.

2. The device of claim 1 and further comprising a circuit board disposed within the enclosure and supporting each of the controller, input, analog to digital converter, and transmitter, wherein the transmitter is wired in parallel with at least one doorbell enunciator AC input.

3. The device of claim 2 wherein the set of wires are soldered to the circuit board.

4. The device of claim 1 wherein the analog to digital converter comprises:
a rectifier;
a resistor and capacitor coupled to the rectifier; and
a switch coupled to the capacitor to turn on responsive to the received ac signal being rectified by the rectifier and integrated by the resistor and capacitor.

5. The device of claim 1 wherein the set of wires comprises:
a first wire to couple to a first doorbell;
a second wired to couple to a second doorbell; and
a common wire.

6. The device of claim 5 wherein the analog to digital converter comprises a pair of analog to digital converters, each coupled to a respective one of the first and second wires, and wherein the pair of analog to digital converter are coupled separately to the controller.

7. The device of claim 1 and further comprising a temperature sensor coupled to the controller.

8. The device of claim 7 wherein the temperature sensor comprises a thermistor.

9. The device of claim 1 and further comprising a tamper sensor coupled to the controller.

10. A method comprising:
receiving an AC signal from a doorbell via a set of wires upon actuation of the doorbell;
converting the received AC signal to a digital signal;
providing the digital signal to a security system controller to generate an alert responsive to the digital signal indicating actuation of the doorbell; and
transmitting the alert via a wireless transmitter coupled to the security system controller via an antenna.

11. The method of claim 10 wherein the method is performed by components supported by a circuit board disposed within an enclosure and wherein the set of wires extend from the circuit board outside the enclosure via an opening in the enclosure.

12. The method of claim 11 wherein converting the received AC signal to a digital signal comprises:
rectifying the received ac signal;
integrating the received rectified ac signal; and
turning on a switch responsive to the integrated received rectified AC signal.

13. The method of claim 10 wherein the set of wires are coupled to two doorbells and converting the received ac signal to a digital signal comprises separately converting the ac signals from the two doorbells and separately providing the converted signals to the controller.

14. The method of claim 10 and further comprising providing a temperature signal to the controller responsive to sensed temperature.

15. The method of claim 10 and further comprising providing a tamper signal to the controller responsive to a tamper switch.

16. A machine readable storage device having instructions for execution by a circuitry to perform a method comprising:
receiving an AC signal from a doorbell via a set of wires upon actuation of the doorbell;
converting the received AC signal to a digital signal;
providing the digital signal to a security system controller to generate an alert responsive to the digital signal indicating actuation of the doorbell; and
transmitting the alert via a wireless transmitter coupled to the security system controller via an antenna.

17. The machine readable storage device of claim 16 wherein the circuitry is supported by a circuit board disposed within an enclosure and wherein the set of wires extend from the circuit board outside the enclosure via an opening in the enclosure.

18. The machine readable storage device of claim 16 wherein converting the received AC signal to a digital signal comprises:
rectifying the received AC signal;
integrating the received rectified AC signal; and
turning on a switch responsive to the integrated received rectified ac signal.

19. The machine readable storage device of claim 16 wherein the set of wires are coupled to two doorbells and converting the received AC signal to a digital signal comprises separately converting the ac signals from the two doorbells and separately providing the converted signals to the controller.

20. The machine readable storage device of claim 16 wherein the method further comprising:
providing a temperature signal to the controller responsive to sensed temperature; and
providing a tamper signal to the controller responsive to a tamper switch.
